(19) United States
(12) Patent Application Publication
(10) Pub. No.: US 2005/0002310 A1
(43) Pub. Date: Jan. 6, 2005

(54) Holographic data storage apparatus and servo control method thereof

(75) Inventors: Seok-ho Song, Seoul (KR); Sung-phil Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/835,604

(22) Filed: Apr. 30, 2004

(30) Foreign Application Priority Data
May 3, 2003 (KR) 2003-28459

(51) Int. Cl. G11B 7/00

(52) U.S. Cl. 369/103; 369/109.01; 369/44.11

(57) ABSTRACT

Disclosed is a servo control method in a disk type holographic data storage apparatus such as a CD-ROM or a DVD-ROM, which has free insertion and extraction characteristics, and the holographic data storage apparatus using the same. Data pixels can be precisely read during the reproduction of the stored holographic data. When a holographic data storage medium having the stored data is rotated, the position of the reproduced holographic data may be deviated from the pixel position in a detector due to errors. A servo control method is conducted to correct the position of the data pixel in the detector. A flat glass is positioned in a 4-f lens system and an angle of inclination of the flat glass is adjusted. The angle of the reference beam is changed while the position of the reference beam is maintained. The light pick-up device may be downsized without using an expensive device such as an acoustic-optic modulator or galvano-mirror.

This application claims benefit under 35 U.S.C. § 119 from Korean Patent Application No. 2003-28459, filed May 3, 2003, the entire content of which is incorporated herein by reference.

### BACKGROUND OF THE INVENTION

1. Field of the Invention

The present invention relates to a servo control method for a holographic data storage and an apparatus for holographic data storage using the same.

2. Description of the Related Art

As an information industry and a computer science industry have been rapidly developed, devices for information storage and input/output have been required to have a high capacity and high speed. Accordingly, increasing attention has been paid to information storage devices which utilize holograms. Holographic data storage apparatuses have high density data storage, which means they can store massive amounts of information in a single space using a volume hologram theory in data recording and reproduction. In addition, since these apparatuses use a parallel data processing method as an input/output method, data input/output speed is enhanced and an access time is reduced without requiring a mechanical driving unit.

Among the various applications of holographic data storage system, a disk type holographic data storage unit such as a CD-ROM or a DVD-ROM, which has free insertion and extraction characteristics, sometimes has a deviation of hologram data from original pixel location of a detector due to several error factors when the disk spins for the reproduction of stored data. A servo control method is conducted to precisely place the data pixel to the pixel location of the detector. To this end, an acoustic-optic modulator (AOM) or a galvano-mirror has been used in a light pick-up device to adjust the incidence angle of the reference beam.

In the above described servo control method, however, the light pick-up device may not be modulated in a small size. Moreover, expensive devices tend to be used for the light pick-up device, which is hard to practice.

### SUMMARY OF THE INVENTION

Accordingly, the present invention is provided to substantially obviate one or more problems due to limitations and disadvantages of the related art.

According to one aspect of the present invention, there is provided a servo control method for a holographic data storage, which, especially in a disk type holographic data storage system such as CD-ROM and DVD-ROM using removable storage medium, reads a data pixel with accuracy during the reproduction of the stored hologram, and a holographic data storage apparatus using the same.

In accordance with one exemplary embodiment of the present invention, a servo control method for a holographic data storage apparatus that records data in a holographic data storage medium using an interference pattern of a signal beam and a reference beam and reads the data recorded in the holographic data storage medium using the reference beam is provided. According to the servo control method, a flat glass having a predetermined thickness is placed between two lenses of a 4-f lens system. The 4-f lens system is positioned on an optical axis of the reference beam that passes through the 4-f lens system and the flat glass. Then, a gradient of the flat glass with respect to the optical axis is adjusted.

The flat glass is preferably placed in a confocal position of the two lenses. The gradient of the flat glass with respect to the optical axis is adjusted to control an incidence angle of the reference beam irradiated onto the holographic data storage medium under the condition that a position of the reference beam is maintained, thereby reading the data recorded in the holographic data storage medium. The holographic data storage medium may have be shaped like a disk.

In accordance with another exemplary embodiment of the present invention, a holographic data storage apparatus that records data in a holographic data storage medium using an interference pattern of a signal beam and a reference beam is provided. The holographic data storage apparatus comprises a flat glass and a servo control unit. The flat glass having a predetermined thickness is interposed between two lenses of a 4-f lens system on an optical axis of the reference beam that passes through the 4-f lens system and the flat glass. The servo control unit adjusts a gradient of the flat glass with respect to the optical axis of the reference beam to control an incidence angle of the reference beam irradiated onto the holographic data storage medium under the condition that a position of the reference beam is maintained.

The flat glass is preferably placed in a confocal position of the two lenses of the 4-f lens system. The holographic data storage medium may be shaped like a disk.

In accordance with still another exemplary embodiment of the present invention, a method of multiplex recording and reproduction of a holographic data storage apparatus that records data in a holographic data storage medium using an interference pattern of a signal beam and a reference beam is provided. According to the method of multiplex recording and reproduction of a holographic data storage apparatus, a flat glass is placed on a path of the reference beam. A gradient of the flat glass with respect to an optical axis of the reference beam is then adjusted to control an incidence angle of the reference beam irradiated onto the holographic data storage medium under the condition that a position of the reference beam is maintained.

The flat glass is preferably placed in a confocal position of two lenses of a 4-f lens system on the optical axis of the reference beam that passes through the 4-f lens system. The holographic data storage medium may be shaped like a disk.

### BRIEF DESCRIPTION OF THE DRAWINGS

The above aspects and features of the present invention will be more apparent by describing certain embodiments of the present invention with reference to the accompanying drawings, in which:

FIG. 1 is a schematic perspective view illustrating a principle that a hologram having a disk shape stores and reproduces information;

FIGS. 2A-2C are schematic cross-sectional views illustrating a servo control method in a holographic data storage apparatus according to an exemplary embodiment of the present invention; and

FIG. 3 is a plan view illustrating a data image displayed in a spatial light modulator to be recorded in a holographic data storage apparatus according to an exemplary embodiment the present invention.

### DETAILED DESCRIPTION OF THE PREFERRED EMBODIMENTS

Certain illustrative, non-limiting embodiments of the present invention will be described in greater detail with reference to the accompanying drawings.

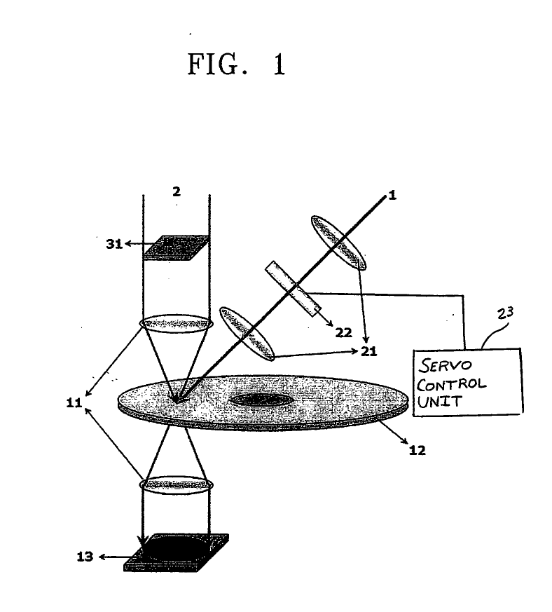

FIG. 1 is a schematic perspective view illustrating a principle that a hologram having a disk shape stores and reproduces data. Referring to FIG. 1, during the recording of holographic data, a signal beam 2 passes through a spatial light modulator (SLM) 31 having a data image to record. The signal beam 2 is then Fourier transformed by a first 4-f relay lens system 11. A reference beam 1 causes data to be stored by interfering with the signal beam 2 via a second 4-f relay lens system 21. During the reproduction of the holographic data, only the reference beam 1 is used to read the stored data by the detector array 13 under the condition that the signal beam 2 is blocked. When errors cause the reproduced data image to be detected outside the pixels of the detector array 13, the angle of inclination of a flat glass 22 is adjusted to correct the position of the reproduced data image prior to irradiating the reference beam 1 onto a disk type holographic data storage medium 12. The flat glass 22 is interposed between two lenses of the second 4-f relay lens system 21 along the optical axis of the reference beam 1. The longitudinal direction of the flat glass 22 is perpendicular to the optical axis of the reference beam 1. The flat glass 22 is adjusted by a servo control unit 23.

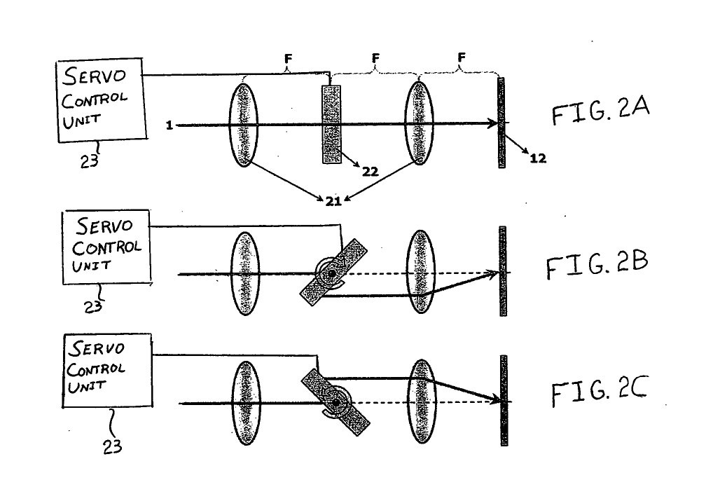

FIGS. 2A-2C are schematic cross-sectional views illustrating a servo control method in a holographic data storage apparatus according to an exemplary embodiment of the present invention. Referring to FIGS. 1 to 2C the flat glass 22 having a thickness of d and a refractive index of n is interposed between two lenses of the second 4-f relay lens system 21. The flat glass 22 is inclined from the optical axis of the reference beam 1. When the reference beam 1 is irradiated onto the disk type holographic data storage medium 12, the angle of inclination of the reference beam 1 is adjusted under the condition that the position of the reference beam 1 is maintained. Thus, the detector array 13 may read the data in a precise position.

When the holographic data storage medium 12 is rotated, the position and angle of the stored data may be changed by several errors. Thus, as the holographic data storage medium 12 moves, the incidence angle of the reference beam 1 toward the surface of the holographic data storage medium 12 should be changed in order to maintain the position of the reproduced holographic data. When parallel light is used as the reference beam 1, the position of the reproduced holographic data is changed according to the angle changes regardless of the horizontal position of the light irradiated onto the holographic data storage medium 12 with respect to the optical axis.

When the incident light is deviated from the position at the time of recording due to the rocking of the holographic data storage medium 12 during the reproduction of the holographic data, the flat glass 22 placed in the confocal position of the two lenses of the second 4-f relay lens system 21 is inclined from the optical axis of the reference beam 1. Only the incidence angle is adjusted while the incidence position of the reference beam 1 on the holographic data storage medium 12 is fixed. Hence, the reproduced data image may be detected in the original position.

If the servo control method is not used during the rotation of the holographic data storage medium 12 (for example, a disk having a compact disk shape), a data pixel irradiated onto the detector array 13 (for example, a charge-coupled device) may be deviated from the original position. This causes errors when reading bit shaped data.

According to the servo control method of the present invention, the flat glass 22 may be inclined from the optical axis of the reference beam 1 by a suitable angle to place the deviated data pixel into a correct position. For example, FIG. 2A shows the flat glass 22 without an incline, and FIGS. 2B and 2C show examples of incline of the flat glass 22. The thickness, size and material of the flat glass 22 may vary in accordance with a size of the system used, desired resolution, manufacturing cost, etc. A transparent plastic material may be used as the flat glass.

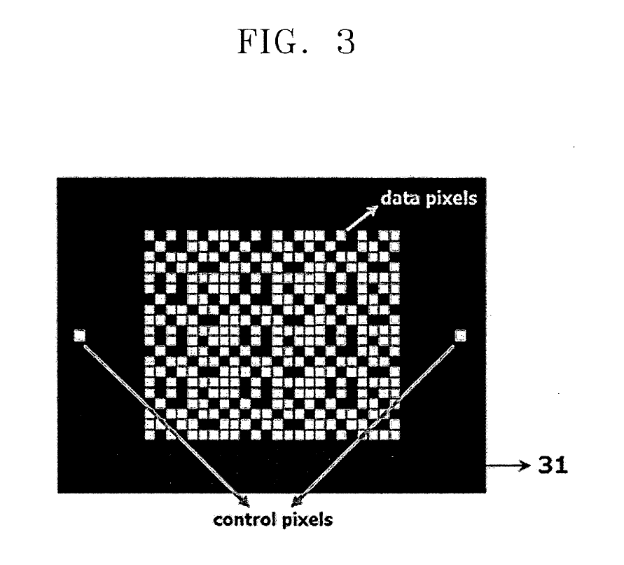

FIG. 3 is a plan view illustrating a data image displayed in a spatial light modulator to be recorded in a holographic data storage apparatus according to an exemplary embodiment of the present invention. As shown in FIG. 3, two-dimensional data including a data pixel and a control pixel is displayed in the spatial light modulator 31. Fourier transformed holographic data is recorded in the holographic data storage medium 12 having the shape of a disk. The data pixel includes the data for storage, and the control pixel acts as a servo control unit. While reproducing the holographic data, the position of the control pixel is analyzed and the angle of inclination of the reference beam 1 is adjusted so that the data pixel is placed in the pixels of the detector array 13.

As described above, the angle of the reference beam is adjusted to increase the storage density during the servo control of the holographic data storage apparatus to read the data precisely according to the present invention. As a result, the position of the holographic data deviated from the original position by errors may be corrected. Moreover, the light pick-up device may be downsized and the manufacturing cost may be reduced. The holographic data storage apparatus according to the present invention may be used in an optical pick-up device of a high capacity holographic data storage apparatus.

The foregoing embodiment and advantages are merely exemplary and are not to be construed as limiting the present invention. Also, the description of the embodiments of the present invention is intended to be illustrative, and not to limit the scope of the claims, and many alternatives, modifications, and variations will be apparent to those skilled in the art.

1. A servo control method for a holographic data storage apparatus that records data in a holographic data storage medium using an interference pattern of a signal beam and a reference beam and reads the data recorded in the holographic data storage medium using the reference beam, comprising:
placing a flat glass having a predetermined thickness between two lenses of a 4-f lens system, the 4-f lens system being positioned on an optical axis of the reference beam that passes through the 4-f lens system and the flat glass; and
adjusting a gradient of the flat glass with respect to the optical axis.

2. The method as claimed in claim 1, wherein the flat glass is placed in a confocal position of the two lenses, and wherein the gradient of the flat glass with respect to the optical axis is adjusted to control an incidence angle of the reference beam irradiated onto the holographic data storage medium under the condition that a position of the reference beam is maintained, thereby reading the data recorded in the holographic data storage medium.

3. The method as claimed in claim 1, wherein the holographic data storage medium has a shape of a disk.

4. A holographic data storage apparatus that records a data in a holographic data storage medium using an interference pattern of a signal beam and a reference beam, comprising:
a flat glass having a predetermined thickness, the flat glass being interposed between two lenses of a 4-f lens system on an optical axis of the reference beam that passes through the 4-f lens system and the flat glass; and
a servo control unit adjusting a gradient of the flat glass with respect to the optical axis of the reference beam to control an incidence angle of the reference beam irradiated onto the holographic data storage medium under the condition that a position of the reference beam is maintained.

5. The apparatus as claimed in claim 4, wherein the flat glass is placed in a confocal position of the two lenses of the 4-f lens system.

6. The apparatus as claimed in claim 4, wherein the holographic data storage medium has a shape of a disk.

7. A method of multiplexing record and reproduction of a holographic data storage apparatus that records a data in a holographic data storage medium using an interference pattern of a signal beam and a reference beam, comprising:
placing a flat glass on a path of the reference beam; and
adjusting a gradient of the flat glass with respect to an optical axis of the reference beam to control an incidence angle of the reference beam irradiated onto the holographic data storage medium under the condition that a position of the reference beam is maintained.

8. The method as claimed in claim 7, wherein the flat glass is placed in a confocal position of two lenses of a 4-f lens system on the optical axis of the reference beam that passes through the 4-f lens system.

9. The method as claimed in claim 7, wherein the holographic data storage medium has a shape of a disk.

10. An apparatus for recording and/or reproducing data using an optical storage medium, comprising:
a detector for detecting data reproduced from the optical storage medium; and
a flat unit having a predetermined thickness for adjusting an incidence angle of a beam irradiated onto the optical storage medium, in response to a position of the reproduced data detected by the detector.

11. The apparatus as claimed in claim 10, wherein the flat unit is interposed between two lenses of a 4-f lens system on an optical axis of the beam irradiated onto the optical storage medium that passes through the 4-f lens system and the flat glass.
